(19) United States
(12) Patent Application Publication
(10) Pub. No.: US 2018/0281558 A1
(43) Pub. Date: Oct. 4, 2018

(54) ACOUSTIC AIR DUCT AND AIR EXTRACTION SYSTEM FOR A MOTOR VEHICLE

(71) Applicant: FORD GLOBAL TECHNOLOGIES, LLC, Dearborn, MI (US)

(72) Inventors: Patrick James Blanchard, Ann Arbor, MI (US); Haibo Zhao, Northville, MI (US)

(21) Appl. No.: 15/473,015

(22) Filed: Mar. 29, 2017

(51) Int. Cl. B60H 1/00

(52) U.S. Cl. CPC B60H 1/00564; B60H 2001/006

(57) ABSTRACT

An air extraction system includes an air inlet, an air extractor in an acoustic air duct extending from the air inlet to the air extractor. The acoustic air duct includes an outer wall defining an elongated area flow passageway and a plurality of channels extending along and dividing the airflow passageway within the outer wall.

### TECHNICAL FIELD

This document relates generally to the motor vehicle equipment field and, more particularly, to an acoustic air duct, an air extraction system for a motor vehicle as well as to a related method of reducing noise transmitted through an air duct.

### BACKGROUND

A motor vehicle air extraction system provides a number of functions, allowing proper air flow inside a passenger cabin of a motor vehicle, controlling window fogging and even reducing door closing effort. Such an air extraction system incorporates an inlet such as a trim panel inlet, an air extractor and an air duct connecting the trim panel inlet to the air extractor.

In order to accommodate a desired airflow inside the passenger cabin, that air duct is ideally designed to have a large diameter and no expansion chamber. In order to control noise, vibration and harshness (NVH), that air duct is ideally designed to have a small diameter and an expansion chamber. This document relates to a new and improved acoustic air duct and a new and improved air extraction system uniquely designed and adapted to meet these seemingly conflicting requirements. A related method of reducing noise transmitted through an air duct is also provided.

### SUMMARY

In accordance with the purposes and benefits described herein, a new and improved acoustic air duct is provided. That acoustic air duct comprises an outer wall defining an elongated internal airflow passageway and a plurality of channels extending along the airflow passageway within the outer wall.

The plurality of channels may have a helical configuration so as to provide a tortuous path to reduce noise transmission through the acoustic air duct.

In some of the many possible embodiments of the acoustic air duct, at least one channel of the plurality of channels may have a circular cross-section. In other of the many possible embodiments of the acoustic air duct, at least one channel of the plurality of channels may have a polygonal cross section. In at least one embodiment of the many possible embodiments of the acoustic air duct, the plurality of channels may form a honeycomb cross section.

In some of the many possible embodiments of the acoustic air duct, the plurality of channels may be made from an acoustic material. For purposes of this document, an acoustic material means a material designed to absorb sound.

In accordance with an additional aspect, an air extraction system is provided for a motor vehicle. That air extraction system comprises an inlet, such as a trim panel inlet, an air extractor and an acoustic air duct extending from the trim panel inlet to the air extractor. The acoustic air duct includes an outer wall defining an elongated airflow passageway and a plurality of channels extending along the airflow passageway within the outer wall.

The plurality of channels may have a helical configuration so as to provide a tortuous path to reduce noise transmission through the acoustic air duct.

In some of the many possible embodiments of the air extraction system, at least one channel of the plurality of channels has a circular cross section. In some of the many possible embodiments of air extraction system, at least one channel of the plurality of channels has a polygonal cross section. In some of the many possible embodiments of air extraction system, the plurality of channels form a honeycomb cross section.

The plurality of channels may be made from an acoustic material.

Each channel of the plurality of channels may have a cross sectional area of between 200 mm² and 2000 mm². Each channel of the plurality of channels may have a length of at least 7.62 cm.

In accordance with still another aspect, a method is provided for reducing noise transmission through an air duct. That method comprises dividing an internal airflow passageway in the air duct with a plurality of channels.

The method may further include the step of providing the plurality of channels in a helical configuration. In addition, the method may include the step of providing the plurality of channels with a honeycomb cross section.

The method may also include the step of making the plurality of channels from an acoustic material. Still further, the method may include the step of extending the air duct from an air inlet, such as a trim panel inlet, to an air extractor. In addition, the method may include the step of providing the internal airflow passageway with a cross sectional area sufficient to provide a predetermined leakage airflow from an interior compartment of a motor vehicle.

In the following description, there are shown and described several preferred embodiments of the acoustic air duct, the air extraction system and the related method of reducing noise transmitted through an air duct. As it should be realized, the acoustic air duct, the air extraction system and the related method are capable of other, different embodiments and their several details are capable of modification in various, obvious aspects all without departing from the acoustic air duct, the air extraction system and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the acoustic air duct, the air extraction system and the related method and together with the description serve to explain certain principles thereof.

FIG. 1 is a schematic illustration of the new and improved air extraction system incorporating the new and improved acoustic air duct.

FIG. 2a is a perspective view of a segment of one possible embodiment of that acoustic air duct.

FIG. 2b is a cross sectional view of the segment of the acoustic air duct illustrated in FIG. 2a.

FIG. 3 is a cross sectional view of an alternative embodiment of the acoustic air duct.

FIG. 4 is a perspective view of a segment of still another alternative embodiment of acoustic air duct incorporating a plurality of channels in a helical configuration.

Reference will now be made in detail to the present preferred embodiments of the acoustic air duct, air extraction system and related method of reducing noise transmitted through an air duct, examples of which are illustrated in the accompanying drawing figures.

### DETAILED DESCRIPTION

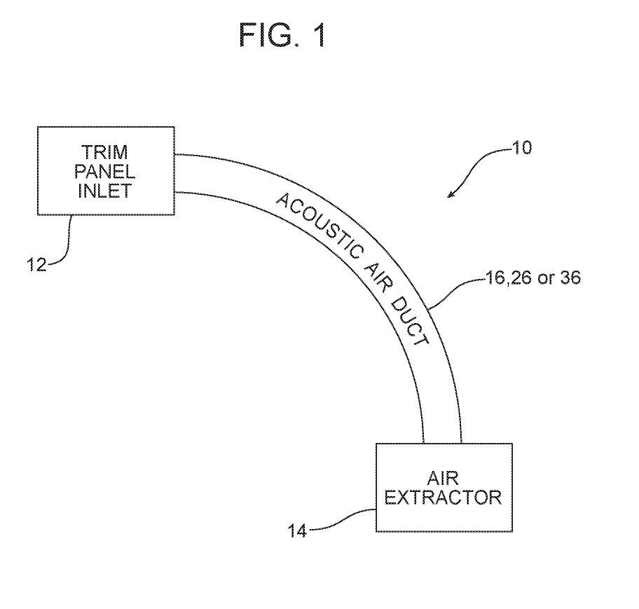

Reference is now made to FIG. 1 which schematically illustrates the new and improved air extraction system 10. That air extraction system 10 includes an air inlet, illustrated as a trim panel inlet 12. The trim panel inlet 12 is located in the passenger compartment of the motor vehicle such as, for example, in the package tray. The air extraction system 10 also includes an air extractor 14 which is typically provided in the sheet metal at the rear of the motor vehicle. In addition, the air extraction system 10 includes an acoustic air duct 16, 26 or 36 that extends from the trim panel inlet 12 to the air extractor 14.

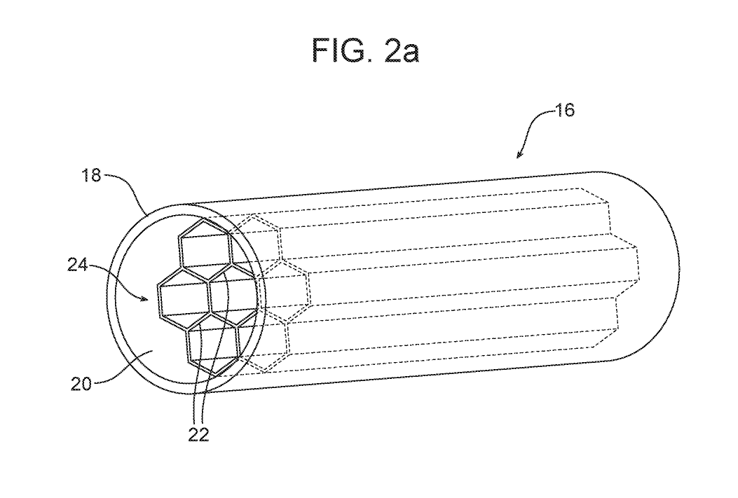

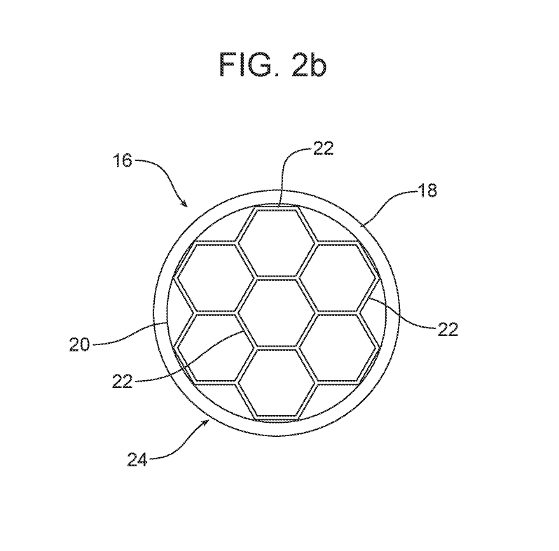

As illustrated in FIGS. 2a and 2b, the acoustic air duct 16 includes an outer wall 18 defining an elongated airflow passageway 20. A plurality of channels 22 extend along the airflow passageway 20 within the outer wall 18.

In the embodiment illustrated in FIGS. 2a and 2b, at least one channel of the plurality of channels 22 has a polygonal cross section. Further, the plurality of channels in the embodiment illustrated in FIGS. 2a and 2b form a honeycomb cross section 24.

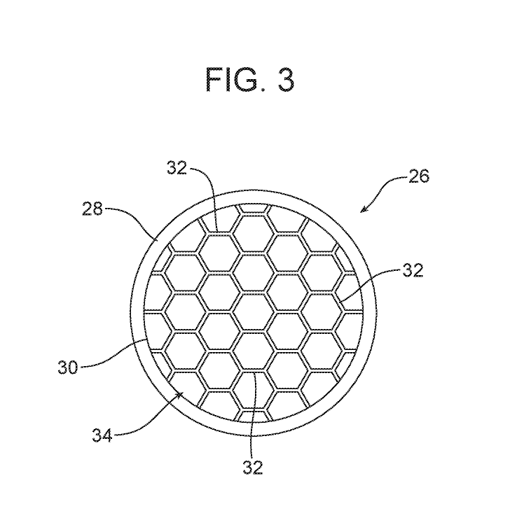

FIG. 3 illustrates an alternative embodiment of acoustic air duct 26 having an outer wall 28 defining an airflow passageway 30. That airflow passageway 30 is divided into a plurality of channels 32 of a different size than those provided in the embodiment illustrated in FIGS. 2a and 2b. The plurality of channels 32, however, also provides a honeycomb cross section.

The outer wall 18 of the acoustic air duct 16 illustrated in FIGS. 2a and 2b and the outer wall 28 of the acoustic air duct 26 illustrated in FIG. 3 are designed to meet the body leakage airflow requirements for providing reduced door closing effort and optimum airflow in the passenger compartment of the motor vehicle. Thus, the airflow passageway 20 and the airflow passageway 30 have a predetermined cross sectional area in order to provide this desired function. The nominal air flow restriction imposed by the plurality of smaller channels 22, 32 still provides the desired function while also reducing noise transmission.

The plurality of channels 22 in the acoustic air duct 16 of the embodiment illustrated in FIGS. 2a and 2b and the plurality of channels 32 of the acoustic air duct 26 illustrated in FIG. 3 have a cross sectional area adapted to reduce NVH. In one possible embodiment, the cross sectional area of each channel of the plurality of channels 22, 32 is between 200 mm² and 2000 mm².

The plurality of channels within the outer wall 18 may extend through any portion or the entire airflow passageway 20. In one particularly useful embodiment, the plurality of channels 22 has a length of at least 7.62 cm. The plurality of channels 32 in the outer wall 28 of the acoustic air duct 26 may also have a length of at least 7.62 cm.

In any of the possible embodiments, the plurality of channels 22, 32 may assume any number of different cross sectional shapes including, but not limited to, circular, oval, polygonal, regular or even irregular.

In any of the possible embodiments, the plurality of channels 22, 32 may be made from an acoustic material. Examples of acoustic materials that may be utilized to absorb or reduce sound include but are not necessarily limited to polyurethane, plastomer such as ethylene-alpha olefin copolymers and polyesters such as polyethylene terephthalate (PET). The outer wall 18, 28 of the acoustic air duct 16, 26 may also be made from an acoustic material if desired. The plurality of channels 22, 32 may be made integral with the outer wall 18, 28 such as by co-extrusion therewith or the plurality of channels may be provided by a separate partition body that is secured within the outer wall. Additive manufacturing may also be used.

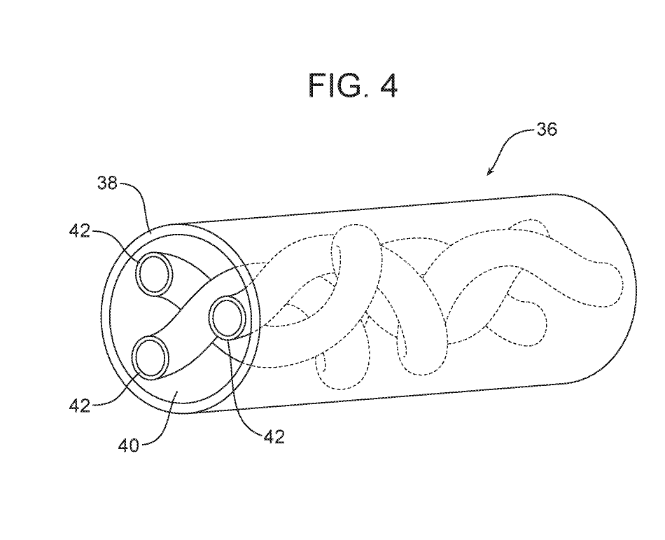

Reference is now made to FIG. 4 illustrating yet another embodiment of the acoustic air duct 36. That acoustic air duct 36 includes an outer wall 38 defining an airflow passageway 40. That airflow passageway 40 is divided by a plurality of channels 42. In the embodiment illustrated in FIG. 4, at least one of the plurality of channels 42 is circular in cross section and the plurality of channels 42 are helical in configuration. While only three channels 42 are illustrated, it should be appreciated that this is done for clarity of illustration of the helical configuration and that, if desired, a greater number of channels 42 may be provided in the airflow passageway 40 within the outer wall 38. Those channels 42 may all be of the same or a mixture of different cross sectional areas and may substantially fill the cross sectional area of the airflow passageway 40.

Each channel 42 may be made from an acoustic material if desired. In addition, each channel 42 may have a cross sectional area of between 200 mm² and 2000 mm² as well as a length of least 7.62 cm. The outer wall 38 may also be made of an acoustic material if desired to aid in reducing NVH. Of course, the helical configuration of the plurality of channels 42 provides a tortuous path that functions to reduce the transmission of noise into the passenger compartment of the motor vehicle through the trim panel inlet 12.

Consistent with the above description, a method is provided for reducing noise transmitted through an air duct such as illustrated at 16, 26, 36 and in FIGS. 2a, 2b, 3 and 4. That method includes the step of dividing an internal airflow passageway 20, 30, 40 in the acoustic air duct 16, 26, 36 with a plurality of channels 22, 32, 42.

The method may include providing those plurality of channels 42 in a helical configuration as illustrated in FIG. 4. Alternatively, or in addition, the method may include providing those plurality of channels 22, 32 with a honeycomb cross section as illustrated in FIGS. 2a, 2b and 3. The method may further include the step of making the plurality of channels 22, 32, 42 from an acoustic material in order to further reduce the transmission of sound through the acoustic air duct 16, 26, 36.

As illustrated in FIG. 1, the method may also include extending the air duct 16 from an air inlet such as a trim panel inlet 12 to an air extractor 14. Further, as noted above, the method may include providing the internal airflow passageway 20, 30 or 40 with a cross sectional area sufficient to provide a predetermined leakage airflow from an interior compartment of the motor vehicle.

In summary, the air extraction system 10 incorporates the trim panel inlet 12, the air extractor 14 and an acoustic air duct 16, 26 or 36 connecting and providing fluid communication between the air inlet/trim panel inlet 12 and the air extractor 14. Advantageously, any of the acoustic air ducts 16, 26, 36 meet the seemingly conflicting requirements for optimizing airflow through the passenger compartment of a motor vehicle while also substantially reducing NVH. As such, the acoustic air ducts, 16, 26, 36 and air extraction system 10 both represent a significant advance in the art.

The foregoing has been presented for purposes of illustration and description. It is not intended to be exhaustive or to limit the embodiments to the precise form disclosed. Obvious modifications and variations are possible in light of the above teachings. For example, the channels 22, 32, 42 may extend through any portion or even all of the entire length of the elongated airflow passageways 20, 30, 40. All such modifications and variations are within the scope of the appended claims when interpreted in accordance with the breadth to which they are fairly, legally and equitably entitled.

What is claimed:

1. An acoustic air duct, comprising:
an outer wall defining an elongated internal airflow passageway; and
a plurality of channels extending along said elongated internal airflow passageway within said outer wall.

2. The acoustic air duct of claim 1, wherein said plurality of channels have a helical configuration so as to provide a tortuous path to reduce noise transmission through said acoustic air duct.

3. The acoustic air duct of claim 1, wherein at least one channel of said plurality of channels has a circular cross section.

4. The acoustic air duct of claim 1, wherein at least one channel of said plurality of channels has a polygonal cross section.

5. The acoustic air duct of claim 1, wherein said plurality of channels form a honeycomb cross section.

6. The acoustic air duct of claim 1, wherein said plurality of channels are made from an acoustic material.

7. An air extraction system for a motor vehicle, comprising:
an air inlet;
an air extractor; and
an acoustic air duct extending from said air inlet to said air extractor, said acoustic air duct including an outer wall defining an elongated airflow passageway and a plurality of channels extending along said elongated internal airflow passageway within said outer wall.

8. The air extraction system of claim 7, wherein said plurality of channels have a helical configuration so as to provide a tortuous path to reduce noise transmission through said acoustic air duct.

9. The air extraction system of claim 7, wherein at least one channel of said plurality of channels has a circular cross section.

10. The air extraction system of claim 7, wherein at least one channel of said plurality of channels has a polygonal cross section.

11. The air extraction system of claim 7, wherein said plurality of channels form a honeycomb cross section.

12. The air extraction system of claim 7, wherein said plurality of channels are made from an acoustic material.

13. The air extraction system of claim 7, wherein each channel of said plurality of channels has a cross sectional area of between 200 mm² and 2000 mm².

14. The air extraction system of claim 13, wherein each channel of said plurality of channels has a length of at least 7.62 cm.

15. A method of reducing noise transmitted through an air duct, comprising:
dividing an internal airflow passageway in said air duct with a plurality of channels.

16. The method of claim 15, including providing said plurality of channels in a helical configuration.

17. The method of claim 16, including providing said plurality of channels with a honeycomb cross section.

18. The method of claim 17, including making said plurality of channels from an acoustic material.

19. The method of claim 18, including extending said air duct from an air inlet to an air extractor.

20. The method of claim 19, including providing said internal airflow passageway with a cross sectional area to provide a predetermined leakage airflow from an interior compartment of a motor vehicle.
